(19) United States
(12) Patent Application Publication
(10) Pub. No.: US 2015/0297926 A1
(43) Pub. Date: Oct. 22, 2015

(54) Self-Extinguishing Sandwich Panel

(71) Applicant: Dariusz Dzegan, Michalowice (PL)

(72) Inventor: Dariusz Dzegan, Michalowice (PL)

(21) Appl. No.: 14/374,313

(22) PCT Filed: Aug. 1, 2012
(86) PCT No.: PCT/PL2012/000062

§ 371 Date: Jul. 24, 2014

(30) Foreign Application Priority Data
Mar. 22, 2012 (PL) P-398 582

(51) Int. Cl. A62C 35/68; E04C 2/52; E04F 13/074; E04C 2/292; A62C 3/00; A62C 37/38

(52) U.S. Cl. CPC A62C 35/68; A62C 3/00; A62C 37/38; E04F 13/074; E04C 2/292; E04C 2/521

(57) ABSTRACT

The present invention is a self-extinguishing sandwich panel to be used as a component of wall and/or roof structures in production halls, warehouses, retail centers, etc. The self-extinguishing sandwich panel is equipped with a core and flow pipes situated under the skin surface, pipes which are distributed on one side of the core or on both sides of the panel core. The panel consists of internal flow pipes (3) that are connected by splines with the sprinkler devices (4), which are situated outside the panel, with the spines passing through holes in the skin (2). The inlet to the system of internal flow pipes (3) has an inlet valve (5), and the outlet has an outlet valve (6). The sprinkler devices (4) may be distributed on one side of the panel. The sprinkler devices (4) may be distributed in a span wise direction and/or over the panel perimeter and/or centrally, with the distribution density of the sprinkler devices depending on the fire load of the facility. The flow pipes (3) may be made of a material that is resistant to high temperature, and may be protected by the panel's skin.

### CROSS REFERENCE TO RELATED APPLICATIONS

This is a National Phase Application filed under 35 U.S.C. §371 as a national stage of PCT/PL2012/000062, tiled on Aug. 1, 2012, an application claiming the benefit of Polish Application No. PL398582, filed on Mar. 22, 2012, the entire contents of which is hereby incorporated by reference in its entirety.

### FIELD OF THE INVENTION

This patent application is directed to a self-extinguishing sandwich panel used as a component of wall and/or roof structures, including, in particular, production halls, warehouses, or retail centers.

### BACKGROUND OF THE INVENTION

Currently known sandwich panels, without sprinkler systems, are used as wall or roof sheathing for buildings with a large floor area, buildings which may be used for industrial purposes, or for storage. In these currently known panels, the insulating core is made of Styrofoam, polyurethane, or rock wool. The core is placed in between two skin layers, typically made of steel plate or another durable material. The material for the skin is selected according to the function of the building being constructed, and the conditions of the environment, including, in particular, the increased exposure to vibrations generated by production equipment, exposure to chemical conditions, exposure to erosion, and temperature variations, particularly variable outdoor temperatures and low temperatures inside the building, as in the case of air-conditioned buildings. Typically, a galvanized steel plate is used for each of the skins.

There are no prior art self-extinguishing sandwich panels that are used for heating or cooling of building surfaces during its daily operation. At the moment, the fire protection system is formed of separate equipment that is installed on the surface of ceilings, and which are supplied with water in the situation where a fire breaks out. Constant water or gas pressure is maintained in the system. In the event of a fire, when the elevated temperature shatters a glass bulb, the firefighting medium, typically water, is released through the opening, directly on to the source of danger. Water is forced to the system from the fire protection tank or from water pipelines.

The solution described in my U.S. Pat. No. 8,074,639, entitled “Building panel,” the disclosures of which are incorporated herein by reference, concern the construction of a sandwich panel with flow pipes installed under the skin of the panel, but it does not disclose a sprinkler system. The flow pipes of the '639 patent may be placed on one or both sides of the sandwich panel. The particular application of the panels of the '639 patent is for use in the construction of an exterior/interior wall or roof structure that provides various thermal effects, such as transmitting the heat energy absorbed by an exterior side of the panel to an interior side of the panel to aid in heating an area of a building on a cold day, or another heat management policy (e.g., cooling therein). However, the panels taught by the '639 patent do not contain a fire protection system, which is disclosed in the present invention.

### OBJECTS OF THE INVENTION

It is an object of the invention to provide a sandwich panel with flow pipes, which may cool down the surface of a building's sheathing.

It is another object of the invention to provide a self-extinguishing sandwich panel that will generate a water curtain to suppress fire.

It is a further object of the invention to provide sprinkler equipment that is installed on one side of the panel.

It is another object of the invention to provide sprinkler equipment that is arranged to be at certain points and/or at the perimeter of the panel, and/or in the center; however, the density of the arrangement depends on the fire load of a given facility where the panel will be used.

It is also an object of the invention to provide a sandwich panel with flow pipes that are made of heat-resistant material.

It is another object of the invention to provide a sandwich panel with flow pipes that are protected by the external skin of the panel.

Further objects and advantages of the invention will become apparent from the following description and claims, and from the accompanying drawings.

### SUMMARY OF THE INVENTION

The present invention is directed to a self-extinguishing sandwich panel, which will generate a curtain of water for suppressing a fire, and for securing the building structure by cooling down the surface of the building sheathing. The panel described in the present invention provides a high level of fire safety for large-sized buildings, production halls, retail areas, and warehouses.

Furthermore, the present invention serves to potentially prevent a fire by means of quickly sprinkling the air to prevent the combustion of flammable dust or gas that may be generated during production processes.

The essence of the invention is the structure of the self-extinguishing sandwich panel, which is made of a core and internal flow pipes installed under the skin, where the pipes may be placed on one side or on both sides of the core. The internal flow pipes of the self-extinguishing sandwich panel are connected be means of stubs projecting out of the panel, in openings made in the skin, to the sprinkler equipment. A flow valve is installed at the inlet to the system of internal flow pipes, and a valve is included at an outlet of the pipes.

### BRIEF DESCRIPTION OF THE DRAWINGS

FIG. 1 illustrates the self-extinguishing sandwich panel of the present invention, which includes flow pipes and sprinkler equipment, and which is shown in an elevation view.

FIG. 2 illustrates a longitudinal cross-section view through the roof-type self-extinguishing sandwich panel of FIG. 1.

FIG. 3 illustrates a short transverse cross-sectional view through the roof-type self-extinguishing sandwich panel of FIG. 1.

FIG. 4 illustrates a wall-type self-extinguishing panel with flow pipes and sprinkler equipment.

FIG. 5 illustrates a longitudinal cross-sectional view of the wall-type self-extinguishing sandwich panel of FIG. 4.

FIG. 6 illustrates a short transverse cross-sectional view of the wall-type self-extinguishing panel of FIG. 4.

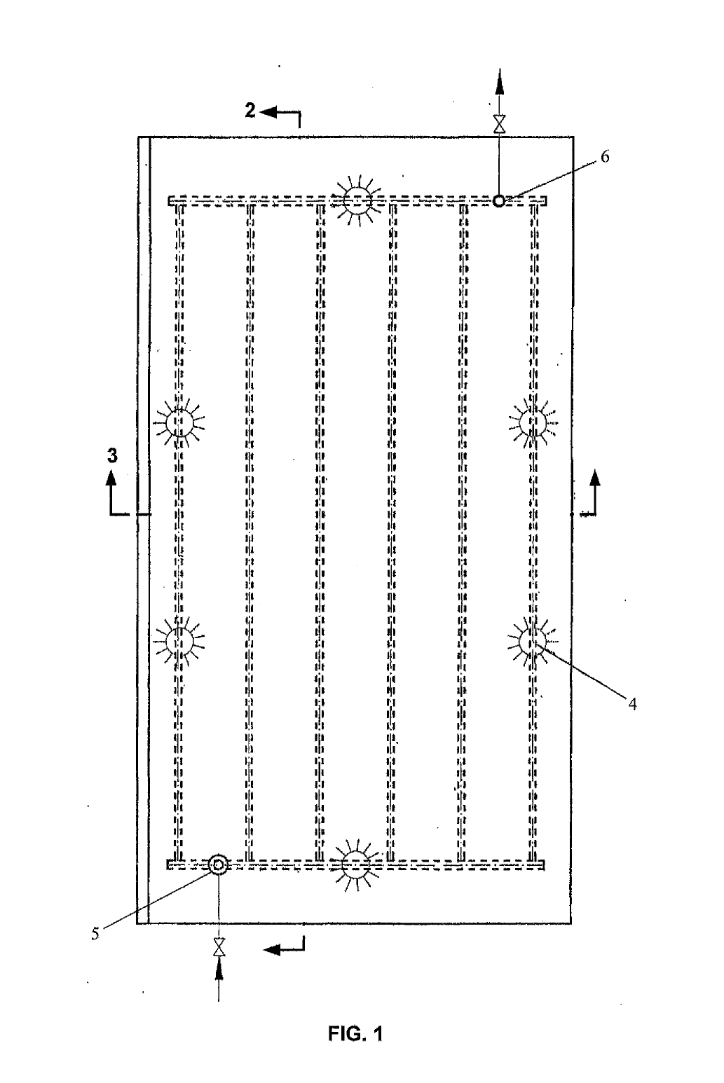

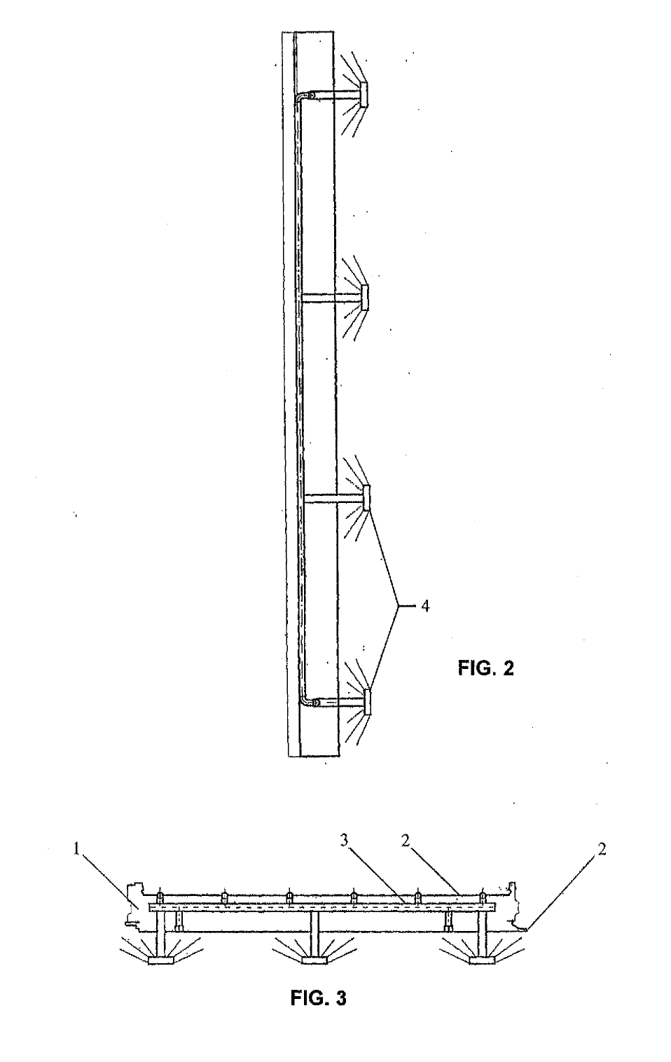

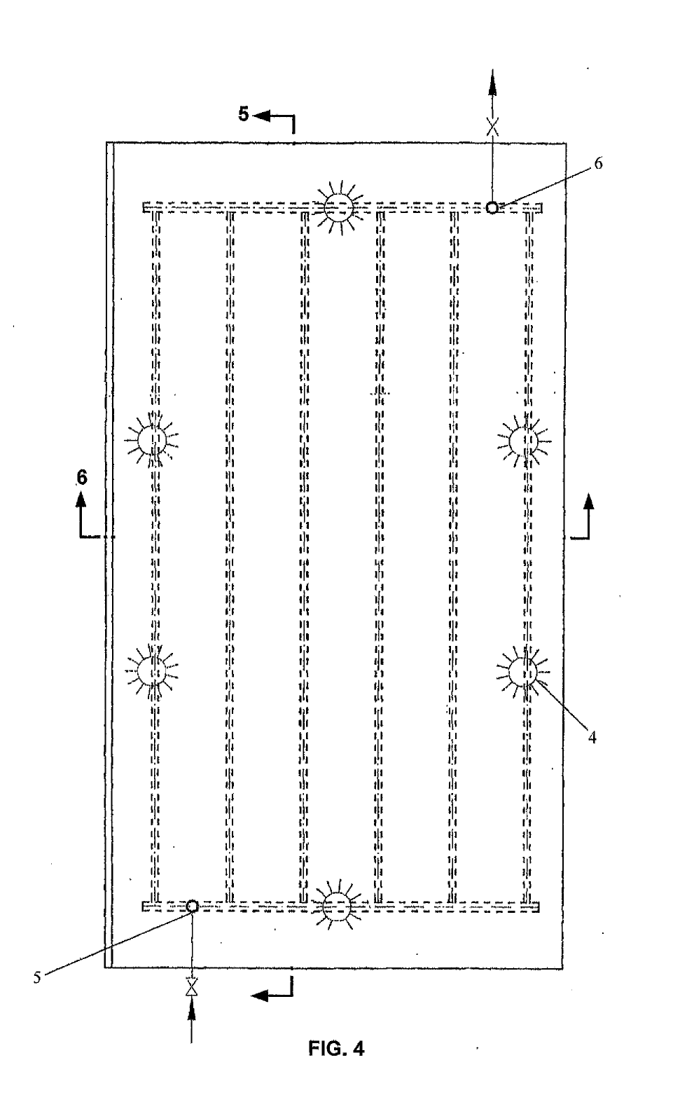

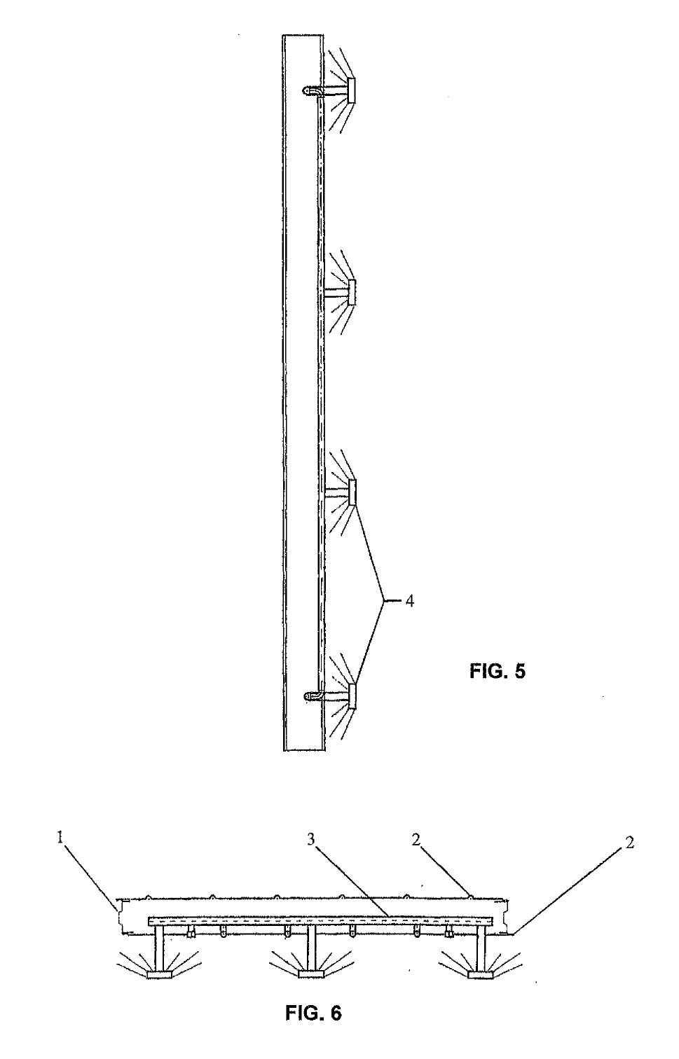

### DETAILED DESCRIPTION OF THE INVENTION

The present invention is directed to a self-extinguishing panel, which combines the features of a building panel and an extinguishing system, to allow for construction of a wall or flooring system which, besides its known application for heat transfer, may also perform a fire protection function. The present invention may minimize losses caused by a fire, save human life and protect health, and protect the building against damage.

During ordinary use, a wall or a flooring system made of the panels of the present invention will cool down or heat up the facility, and in an emergency situation in the event of a fire, it will extinguish the fire and protect the building against damage caused by high temperatures. Due to use of the constantly circulating water in the pipes herein, its further use as an extinguishing agent allows for a quick response by the system in the event of a fire. Furthermore, the system may also be used, if required, to perform rapid cleaning of the air that resulted from dust generated during production, or to dilute gases, thereby serving to prevent an explosion.

The self-extinguishing composite roof panel of the present invention may include the core 1, the skins 2, internal flow pipes 3, sprinkler devices 4, and an inlet valve S and outlet valve 6. The internal flow pipes 3 are connected by splines with the sprinkler devices 4, which are situated outside the panel, using holes formed in the skin 2. The internal flow pipes 3 are provided on the one side of core 1. The sprinkler devices 4 may be distributed in the span wise direction and may be connected to internal flow pipes 3 on one side of the panel. The sprinkler devices 4 may be set up in such a way that they cool down the panel during extinguishing and allow for sprinkling of the desired area of the building surface during the extinguishing action.

The self-extinguishing sandwich panel, designed to be a structural element of the building, is provided with an insulating core 1, with the skins 2, internal flow pipes with the sprinkler devices 4, and an inlet valve 5 and an outlet valve 6. The internal flow pipes 3 are connected to the sprinkler devices 4, which are situated outside the panel, by splines that pass through holes that may be formed in the skin 2. The internal flow pipes 3 may be provided on one side of core 1. The sprinkler devices 4 may be distributed about the panel and may be connected to the internal flow pipes 3 on one side of the panel. The sprinkler devices 4 may be set up in such a way that they cool down the panel during extinguishing and may also allow sprinkling of the desired area of the building surface during the extinguishing action.

Should a temperature rise occur, sprinkler devices 4 may become activated so that the fire extinguishing is commenced. In the event of a fire, valve 6 may be closed and the liquid may flow through sprinklers 4. Water may be obtained for fire-fighting needs from a water tank via the inlet valve 5. The normal function of the hydraulic installation of the system is directed to cooling or heating of the building. The liquid that flows through the system formed by a set of self-extinguishing panels remains in constant motion, and serves as a carrier for thermal energy. The activation of sprinkler devices 4 change the function of the system and its designation.

The examples and descriptions provided merely illustrate a preferred embodiment of the present invention. Those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the preferred embodiment without departing from the spirit of this invention.

What is claimed is:

1. A panel, for use in forming a wall, a roof, or a floor of a building, for use in transferring heat into or out from the building interior, and for use in generating a curtain of water on one side of the panel for suppressing and/or extinguishing fire, said panel comprising:
a core having at least a first side surface and a second side surface;
at least one pipe disposed within said core;
a first skin secured to at least a portion of said first side surface of said core;
a second skin secured to at least a portion of said second side surface of said core;
an inlet valve having a first end configured to receive a flow of fluid, and a second end coupled to a first portion of said at least one pipe, to be in fluid communication therewith;
an outlet valve having a first end coupled to a second portion of said at least one pipe, to be in fluid communication therewith, and a second end configured to output the flow of fluid from said at least one pipe; and
at least one sprinkler positioned proximate to said first skin, said at least one sprinkler coupled, through a hole in said first skin and said core, to said at least one pipe, to be in fluid communication therewith.

2. The panel according to claim 1, further comprising means for closing said outlet valve and for activating said at least one sprinkler, in the event of a temperature rise due to a fire.

3. The panel according to claim 2, wherein said at least one activated sprinkler is configured to sprinkle and cool the panel during the suppressing/extinguishing, and to sprinkle the building interior during the suppressing/extinguishing.

4. The panel according to claim 3, wherein said at least one pipe disposed within said core comprises:
a plurality of pipes each extending in a length-wise direction of said panel, and being evenly distributed span-wise across said panel, with said inlet valve coupled to a first end of each said plurality of pipes, and with said outlet valve coupled to a second end of each said plurality of pipes.

5. The panel according to claim 4, wherein said at least one sprinkler positioned proximate to said first skin comprises:
a plurality of sprinklers positioned proximate to said first skin, each coupled, through said skin and core, to one of said pipes, to be in fluid communication therewith.

6. The panel according to claim 5, wherein said plurality of sprinklers are distributed across said first skin of said panel.

7. The panel according to claim 6,
wherein said first end of said inlet valve is disposed to have a portion protrude from said first skin panel; and
wherein said second end of said outlet valve is disposed to have a portion protrude from said first skin panel.

8. The panel according to claim 7, wherein said pipes comprise a material configured to withstand high temperatures.

9. The panel according to claim 8, wherein said core comprises an insulating material from the group of insulating materials consisting of: Styrofoam; polyurethane; and rock wool.

10. The panel according to claim 9, wherein said skin comprises a galvanized steel plate.

11. A building panel comprising:
a core having at least a first side surface and a second side surface;
at least one pipe disposed within said core;
a skin secured to at least a portion of said first side surface of said core, and to at least a portion of said second side surface of said core;
an inlet valve having a first end configured to receive a flow of fluid, and a second end coupled to a first portion of said at least one pipe, to be in fluid communication therewith;
an outlet valve having a first end coupled to a second portion of said at least one pipe, to be in fluid communication therewith, and a second end configured to output the flow of fluid from said at least one pipe; and
at least one sprinkler positioned on one side of said skin, said at least one sprinkler coupled, through a hole in said skin and said core, to said at least one pipe, to be in fluid communication therewith.

12. The building panel according to claim 11, further comprising means for closing said outlet valve and for activating said at least one sprinkler, in the event of a temperature rise due to a fire.

13. The panel according to claim 12, wherein said at least one activated sprinkler is configured to sprinkle and cool the panel, and to sprinkle the building interior.

14. The building panel according to claim 13, wherein said at least one pipe disposed within said core comprises:
a plurality of pipes each extending in a length-wise direction of said panel, and being evenly distributed span-wise across said panel, with said inlet valve coupled to a first end of each said plurality of pipes, and with said outlet valve coupled to a second end of each said plurality of pipes.

15. The building panel according to claim 14, wherein said at least one sprinkler positioned on said one side of said skin comprises:
a plurality of sprinklers on said one side of said skin, each coupled, through said skin, to one of said pipes to be in fluid communication therewith.

16. The building panel according to claim 15, wherein said plurality of sprinklers are distributed across said one side of said panel.

17. The building panel according to claim 16,
wherein said first end of said inlet valve is disposed to have a portion protrude from said one side of said panel; and
wherein said second end of said outlet valve is disposed to have a portion protrude from said one side of said panel.

18. The building panel according to claim 17, wherein said pipes comprise a material configured to withstand high temperatures.

19. The building panel according to claim 18, wherein said core comprises an insulating material from the group of insulating materials consisting of: Styrofoam; polyurethane; and rock wool.

20. The building panel according to claim 19, wherein said skin comprises a galvanized steel.
